(19) United States
(12) Patent Application Publication
(10) Pub. No.: US 2012/0197996 A1
(43) Pub. Date: Aug. 2, 2012

(54) METHOD AND SYSTEM FOR LIMITED SHARING OF DIGITAL CONTENT

(75) Inventors: Rajeev Raman, Cupertino, CA (US); Hariharan Venkata Chinnaswamy, San Jose, CA (US); Daniel G. Zuck, Santa Clara, CA (US)

(73) Assignee: Control-Bit Technologies, Ltd., Cupertino, CA (US)

(21) Appl. No.: 13/363,267

(22) Filed: Jan. 31, 2012

Related U.S. Application Data
(60) Provisional application No. 61/438,134, filed on Jan. 31, 2011.

(51) Int. Cl. G06F 15/16

(52) U.S. Cl. 709/204

(57) ABSTRACT

A method and system for limited sharing of digital content is disclosed. In one embodiment, a computer-implemented method, comprises receiving a first data stream from a user appliance over a network, the first data stream including user-authentication and content; and receiving a second data stream from a control computer, the second data stream including user-determined content sharing instructions.

### RELATED APPLICATIONS

Applicant claims priority to Application 61/438134, filed on Jan. 31, 2011; and incorporates the entirety of Application 61/438134 in this document by this reference.

### FIELD

The present invention relates to computer software for devices interacting with Internet-based social media websites.

### BACKGROUND

Social networking over the Internet has become popular all over the world. For example, in 2011, Facebook Inc. of Palo Alto, Calif. (website: www.facebook.com) recorded over 800 million active users, which is more than ten percent of world population. Other examples of Internet-based social media services having millions of users are Google+ and YouTube, provided by Google Inc. of Mountain View, Calif. (website: www.google.com), MySpace, provided by Specific Media LLC of Beverly Hills, Calif. (website: www.mvspace.com), Twitter, provided by Twitter, Inc. of San Francisco, California (website: www.twitter.com), and Tumblr, provided by Tumblr, Inc., of New York, N.Y. (website: www.Tumblr.com). This specification refers to these services and websites, in respective order, as “Facebook,” “Google+,” “YouTube,” “MySpace,” “Twitter,” and “Tumblr.”

On Facebook and other services, users share user-supplied content such as text, photographs, and videos. FIG. 1 is a schematic diagram that illustrates an exemplary service. In FIG. 1, user 101 interacts with user appliance 102, which is capable of communicating over network 103 with sharing service 104. Sharing service 104 includes servers 105a-b which provide resources, such as stored content, to user 101, or other users. The user appliance may be, for example, a phone, smart phone, laptop or desktop or tablet computer. The network may include, for example, a public packet switched network (Internet), private packet switched network, or wireless microwave (cellular) and radio (Wi-Fi) networks. The network may be comprised of sub-networks. To share, the user provides content such as a photo or video or text to the sharing service by uploading it over the network. The sharing servers then provide the content to other users of the sharing service. These other users may then interact by uploading content in reply.

Content sharing is characteristic of social media. Users desire content sharing in part because the service forms a community. Indeed, in early forms of social media, the scope of sharing of user content was practically unrestricted: any user could look at another user's content. Unfettered by sharing limitations, a user could interact with a wide variety of others to discover, “keep up,” etc., and allow others to discover, “keep up,” and generally interact with them.

Nearly unrestricted content sharing combined with explosive growth in active users raises a problem; undesired or unintended content sharing. If shared too broadly, writings, photographs and other content may lead to embarrassment, shame, loss of reputation, or other undesired results. Indeed, fear of unintended content sharing may make potential users reluctant to join a service, or active users may abandon a service after an instance of undesired sharing.

Social media services responded to such concerns by engineering features on their websites that offer a user control over the scope of content sharing: a user can limit sharing. For example, a user logs onto Facebook and—using the Facebook's software features—identifies other users (“friends”) with whom to share content, such as a photo. The service denies other users' requests for sharing. Non-friends are thus excluded from viewing the photo. In another example, a user accesses Facebook and identifies a folder of photos that may be shared with all other users, and photos that may be shared only with friends.

But users often misunderstand or misapply sharing service control features, or forget to amend the feature's settings as they provide new content. As a result, unintended sharing continues to be a problem. Accordingly, users need accessible, easy-to-understand, and easy-to-implement software controls that enable the user to limit the scope of content sharing.

### SUMMARY

A method and system for limited sharing of digital content is disclosed. In one embodiment, a computer-implemented method, comprises receiving a first data stream from a user appliance over a network, the first data stream including user-authentication and content; and receiving a second data stream from a control computer, the second data stream including user-determined content sharing instructions.

### BRIEF DESCRIPTION OF THE DRAWINGS

Drawings, which are a portion of this specification, explain and teach aspects, advantages and novel features of the invention and facilitate the description of various embodiments, however, the drawings do not describe every aspect of the teachings disclosed herein and do not limit the scope of the claimed invention.

FIG. 1 is a schematic diagram that depicts information flow for an exemplary content sharing service;

FIG. 2 is a schematic diagram that depicts information flow in accord with an embodiment of the present invention;

FIG. 3 is a schematic diagram that illustrates a sharing service's adoption of the present invention;

FIG. 4 is a flowchart that depicts steps of a software application executing on a user appliance;

FIG. 5 is a flowchart that illustrates the control computer acting on behalf of a user to delete content from the sharing service;

FIG. 6 contains a sequence of images from a user appliance screen illustrating a user interface;

FIG. 7 contains a images from a user appliance screen illustrating features in accord with an embodiment of the present invention;

FIG. 8 contains a images from a user appliance screen illustrating features in accord with an embodiment of the present invention;

FIG. 9 contains a images from a user appliance screen illustrating features in accord with an embodiment of the present invention in relation to text content;

FIG. 10 contains a sequence of images from a user appliance screen illustrating features in accord with an embodiment in relation to audio content; and

FIG. 11 contains images from a user appliance screen illustrating features in accord with an embodiment of the present invention.

These figures are not necessarily drawn to scale, and elements of similar structures or functions are generally represented by like reference numerals for illustrative purposes throughout the figures.

### DETAILED DESCRIPTION

A method and system for limited sharing of digital content is disclosed. In one embodiment, a computer-implemented method, comprises receiving a first data stream from a user appliance over a network, the first data stream including user-authentication and content; and receiving a second data stream from a control computer, the second data stream including user-determined content sharing instructions.

In another embodiment, a method includes presenting a user with a prompt to select at least one scope-of-sharing parameter; receiving the selected parameter(s); generating first sharing instructions based on the selected parameter(s); initiating transmission of user-authentication and content to a sharing service; and initiating transmission of user-authentication and second sharing instructions to a control computer, which is configurable to communicate with the sharing service to establish the selected scope-of-sharing by executing the second sharing instructions.

In yet another embodiment, a system includes a software distribution component that distributes software for user appliances. The software associates content to be shared with one or more user-selected scope-of-sharing parameters. The system also includes a control component that is configurable to receive sharing instructions from the user appliance and transmit the sharing instructions to the content sharing service in a form adapted to the sharing service.

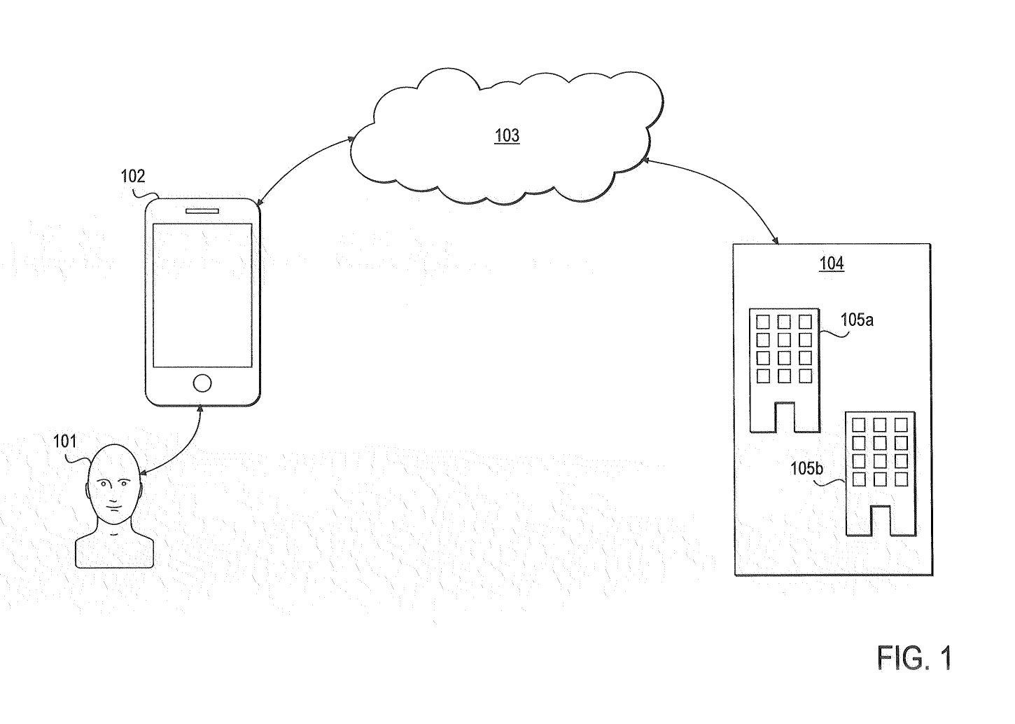

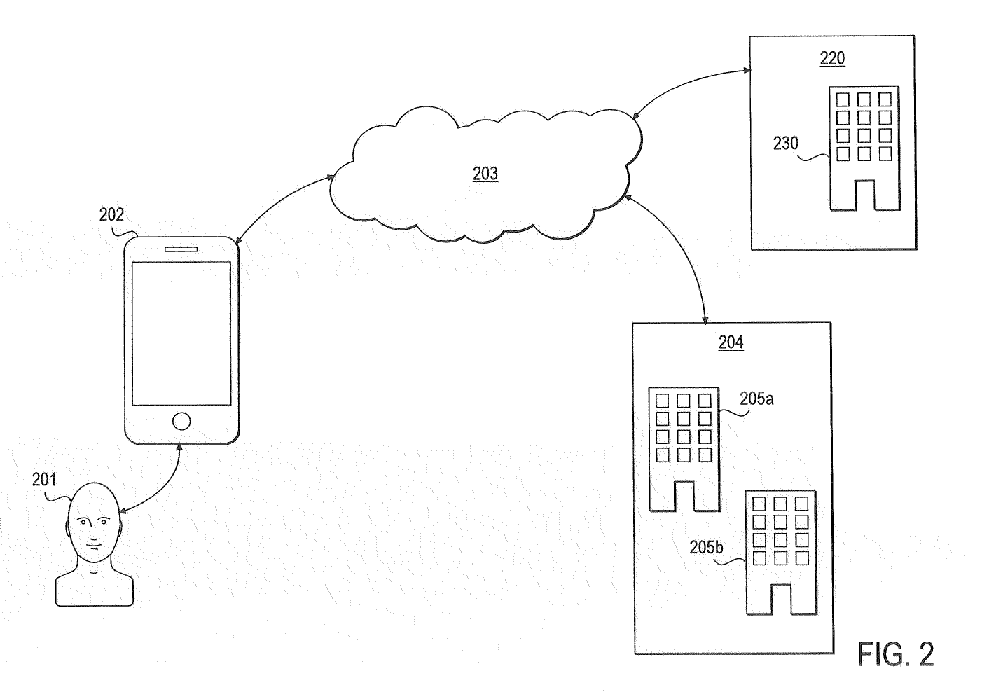

FIG. 2 is a schematic diagram that depicts information flows in accord with embodiments of the invention. User 201, user appliance 202, network 203, sharing service 204, and servers 205 are as like-named and like-numbered elements of FIG. 1. Control service 220 includes control computer 230, which communicates to the user appliance and the sharing service over the network. Other embodiments (not shown) may include a second network over which the control computer communicates with the sharing service. Many network variations are possible.

FIG. 2 illustrates an aspect of the invention: user interaction with the sharing service is bifurcated. Instead of accessing the sharing service to limit content sharing as described with respect to FIG. 1, a user transmits sharing instructions to the control service and control computer over the network. In turn, the control computer executes software that enables the control computer to act as an agent for the user by subsequently communicating with the sharing service.

The above-described bifurcation positions the control computer to act as the user's agent. The software executed on the control computer can receive sharing instructions derived from interfacing with the user in a manner that may be more simple and clear from the point-of-view of a user, as compared to the sharing service features, which may be less than clear or cumbersome. The control computer software may then communicate with the sharing service and express the instructions in a manner appropriate for the sharing service's features. Also, bifurcation to an agent readily allows implementing a schedule, for example moving all photos in a shared folder to a private folder after one month. A sharing service, by contrast, may not offer scheduling at all.

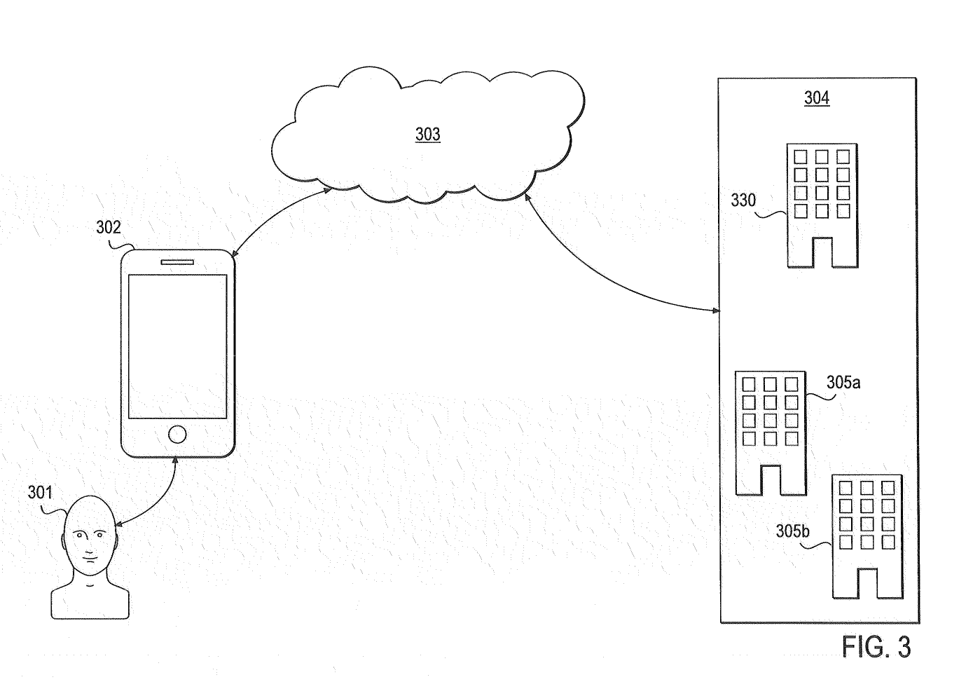

Embodiments of the invention are readily adoptable by a sharing service. FIG. 3 illustrates an embodiment of the invention in which figure elements are as like-named and like-numbered elements of FIG. 2, except that sharing service 304 includes control computer 330.

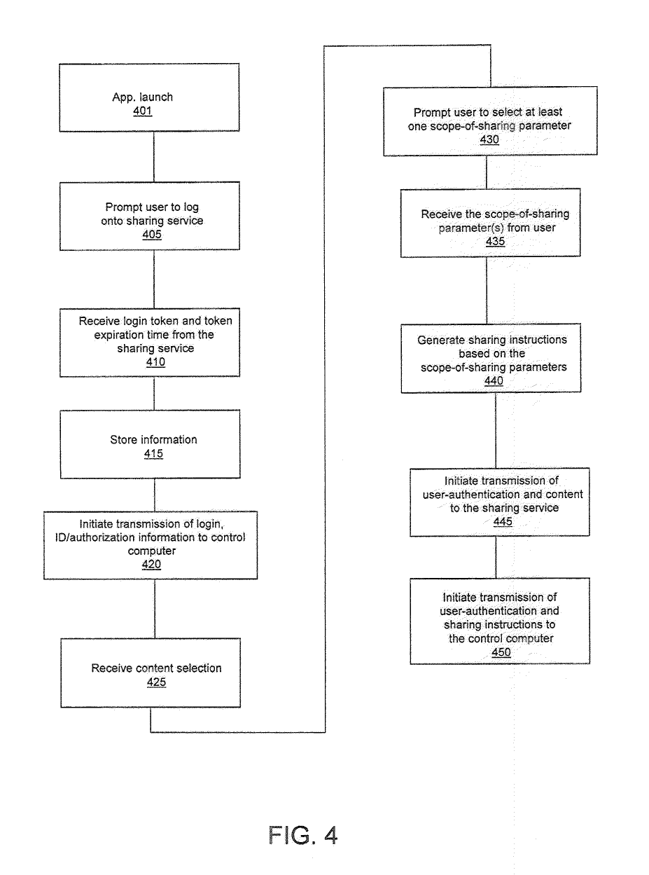

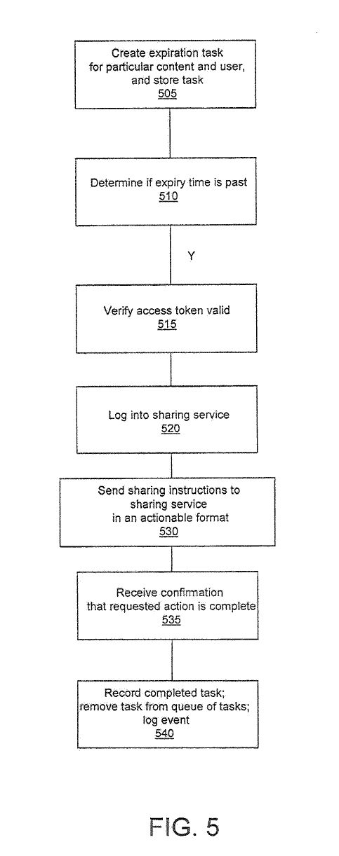

FIG. 4 and FIG. 5 illustrate further aspects of the invention. FIG. 4 is a flow chart that depicts exemplary steps of a software application (“App.”), which executes on a processor in a user appliance (FIG. 2). FIG. 5 is a flow chart that depicts an example of the control computer acting on behalf of the user to limit sharing on the sharing service (FIG. 2).

Turning to FIG. 4, in block 401, a user launches the App. In block 405, the App. prompts the user to log onto the sharing service. Preferably, the App. is consistent with secure authentication protocols such as OAuth (See website: http://oauth.net/). As an option, the App. may prompt the user to agree to agency with respect to actions affecting the user's content. In block 410, the App. receives a login token and token expiration time from the sharing service. The App. may also receive other identification information from the sharing service, such as user profile ID, first/last name, which is internal to the sharing service.

In block 415, the App. stores information such as login and identification/authorization in memory at the user appliance. Login and identification/authorization information typically includes names, user identification, profile name, and the login token and token expiration time. Typically, though not necessarily, App. embodiments store only authentication information, such as token information, not identification information. At block 420, the App. initiates transmission of the login and identification/authorization information to the control computer. The control computer stores the information in memory. In different embodiments, the App. may initiate transfer to the control computer before, or after, or simultaneous with, the transmission of content from the user appliance to the control computer.

In block 425, the App. receives a content selection from the user. The content may exist in storage, or the user may proceed to create content with the appliance, such as by composing a message, or creating a photographic image. Optionally, the user can join newly-created and already-existing content, such as by adding a caption or title to an already-existing, stored photo.

In block 430, the App. presents the user with a prompt to select at least one scope-of-sharing parameter for the content. In block 435, the App. receives the at least one scope-of-sharing parameter from the user.

In embodiments of the invention, content refers to digital information, which can take very many forms: for example and not limitation, text, symbols, characters, icons, sound, still images, and moving images. Many scope-of-sharing parameters are evident to a skilled person. These include, without limitation, expiry time, time-to-archive, time-to-relocate, time-for-action by the control computer, other users or groupings of users with whom to share or exclude from sharing, content characteristics such as file size, dates, geotags, image/video definition, and indicia of reactions by others, such as associated Facebook “likes” and commentary. Typical embodiments have at least expiry time and a user group as scope-of-sharing parameters. Typical embodiments also include a user-selectable default value for a scope-of-sharing-parameter: for example, “Never” for a default expiry time; and “Friends” for a user group. In other embodiments, a user can generate her scope-of-sharing parameters or select from a list.

In block 440, the App. generates sharing instructions based on the user's input of at least one scope-of-sharing parameter. In some embodiments, the sharing instruction may be as simple as the scope-of-sharing parameters alone. In other embodiments, the sharing instructions are more complex than the parameters alone; for example to express the users intended scope-of-sharing into an instruction set adapted to the particular sharing service. Typically, more complex instructions are formed by executing software on the control computer, which may be more capable than the user appliance in terms of technical figures of merit such as processing speed, and memory.

In block 445, the App. initiates transmission of user-authentication and content, which may include associated metadata, to the sharing service over the network. In a typical embodiment, the App. uses programming interfaces (“APIs”) from the sharing service, and transmits the access token from the sharing service with the content. In many instances, the sharing service responds with a unique identifier for the content that has just been uploaded to the service.

In block 450, the App. initiates transfer of user-authentication and sharing instructions to the control computer. The sharing instructions may include a content identifier, which was received from the sharing service after successful upload or generated by the App. The sharing instructions may also include user information such as the user's profile name or username on the service. Many variations are apparent to a skilled person.

Blocks 445 and 450 show that the App. initiates transmission of user-authentication data. In alternate embodiments, the App. initiates transmission of user-identification.

FIG. 4 thus illustrates the App., executing on the user appliance, providing the control computer with user-authentication and sharing instructions: the App. associates the user, the user's content, and the user's desired scope-of-sharing for the content. As illustrated in FIG. 2, the control computer passes the information on to the sharing service, for example to implement a schedule. In other embodiments, the control computer can manipulate the information received from the App., through software that incorporates a reliable understanding of features of the sharing site, in order to formulate instructions for the sharing service that are consistent with the user's desired scope-of-sharing and the features of the sharing service.

FIG. 5 is a flow chart that illustrates the control computer (See FIG. 2.) acting on behalf of a user to delete content from the sharing service. In block 505, the control computer creates and records an expiration task on behalf of the user by creating a unique identifier for the task and associating it with the user and the content to be affected by the task. In block 510, the control computer determines that a user-selected expiry time is passed. Blocks 515 and 520 illustrate exemplary steps to contact the sharing service: in block 515 the control computer verifies that the access token, which the control computer previously received from the user appliance (See FIG. 2.), is still valid; and in block 520, the control computer logs into the sharing service using the access token and stored user information. Other contact steps are possible, depending on the sharing service. In block 530, the control computer sends, and the sharing service receives, a data stream that includes sharing instructions in a form adapted to the sharing service such that the sharing instructions are actionable by the sharing service. One aspect of the adaptation relates to forming an instruction set that is tailored to what a sharing service is set to receive in terms of parameters and actions: the sharing service may require certain parameters or semantics or syntax. Another aspect is technical: typically, software on the control server and software on the sharing service interface with application programming interfaces (APIs), which are well-known in the software arts. In this embodiment, the sharing instructions are to delete content on the sharing service. Optionally, the sharing instructions may be other than to delete content: for example, and not limitation, to move the content to an unshared area on the sharing service, or another location, or limit access/viewing. In block 535, the control computer receives a confirmation from the sharing service that the requested action is complete. In block 540, the control computer records in its memory that the task is complete, removes the task from its queue, and logs the event.

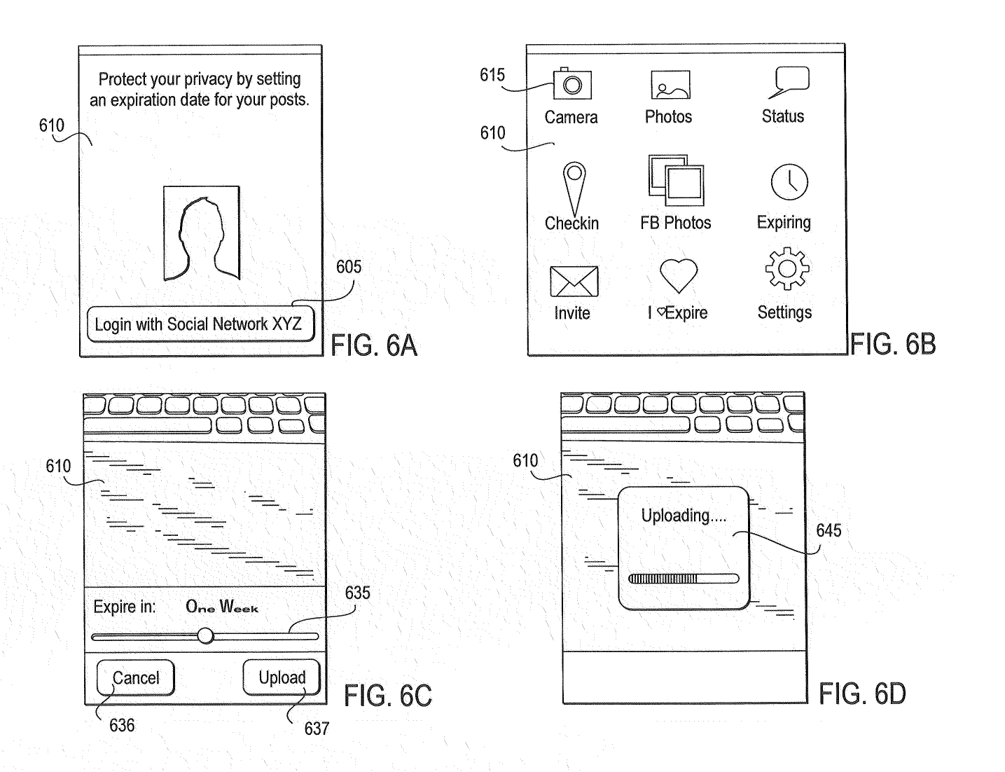

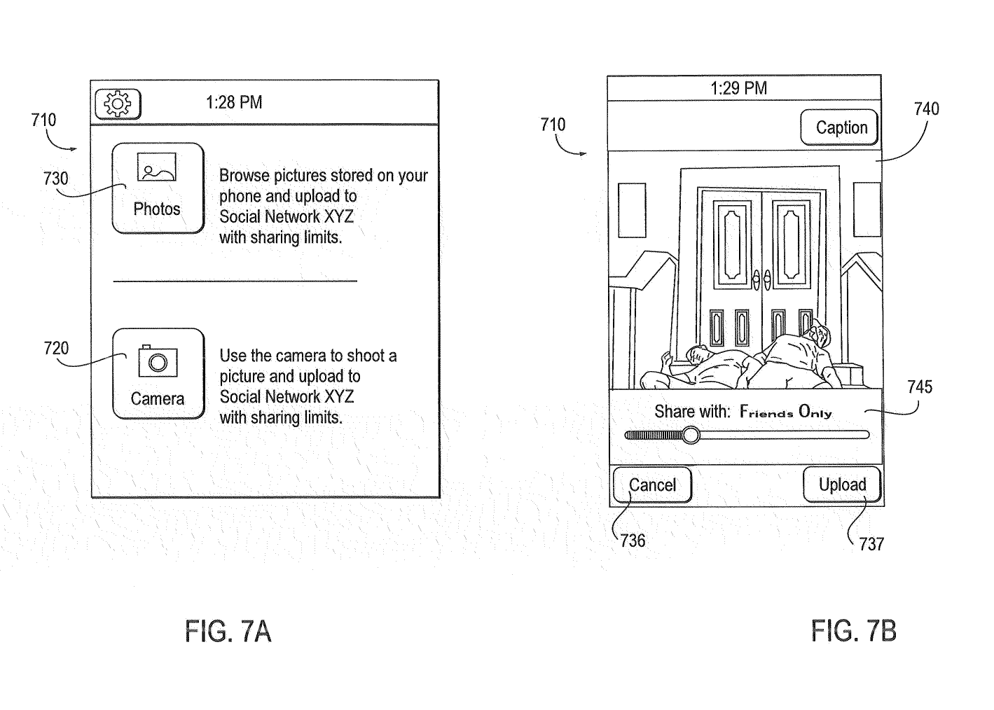

FIGS. 6-11 are depictions of a screen of a user appliance (See FIG. 2.) that illustrate embodiments of user-App. interfaces. FIG. 6 shows portions of a sequence described in the flow chart of FIG. 4. FIGS. 7-11 show particular screens that illustrate features of embodiments of the App.

Turning to FIG. 6, FIG. 6A shows screen 610 after a user starts the App. This corresponds to block 405 of FIG. 4. The screen includes logon icon 605 to prompt the user to log onto a sharing service such as Facebook. FIG. 6B illustrates screen 610, which is in the form of a “home” screen and includes function icons 615 for App. functions, such as camera, photo albums, status messages, geographic location content tagging, expiry and invitation functions, and settings. From these, following a description of FIG. 4 at about block 425, a user, for example, selects the camera function to create content such as a photo. FIG. 6C shows the screen and a prompt to the user to select a scope-of-sharing parameter, an expiry date, with slider icon 635. FIG. 6C depicts that the user selected an expiry date of one week from the present time. Upload icon 637 prompts the user to upload, or transfer, the content to the sharing service. Cancel icon 636 enables the user to cancel the upload. This follows the description of FIG. 4 at about block 445. FIG. 6D shows the screen after the user appliance has initiated transfer of content to the sharing service. The user monitors a graphical representation of the progress, or status, of the transfer operation with progress icon 645.

FIG. 7 contains images from a user appliance screen illustrating aspects of the App. and broad principles of the invention. One aspect of the invention is that scope-of-sharing limits may be applied to both newly made and already existing content. In FIG. 7A screen 710 includes icons to prompt a user to select camera icon 720, which will create a new photograph with a camera, or album icon 730, which provides an option to proceed with existing photographs. Another aspect of the invention is that the App. prompts the user to select scope-of-sharing parameters in part by showing a representation of the content as a reminder about what is being shared. In FIG. 7B, screen 710 shows content representation 740, slider icon 745, cancel icon 736, and upload icon 737. The content representation may, as in FIG. 7B, be a smaller or cropped version of an original photo. The slider icon allows the user to, with a hand gesture, scan through a range of people with whom to share the photo. By sliding or swiping or other hand gesture, a user can select the desired scope-of-sharing. The cancel icon and upload icon are as described above with respect to FIG. 6.

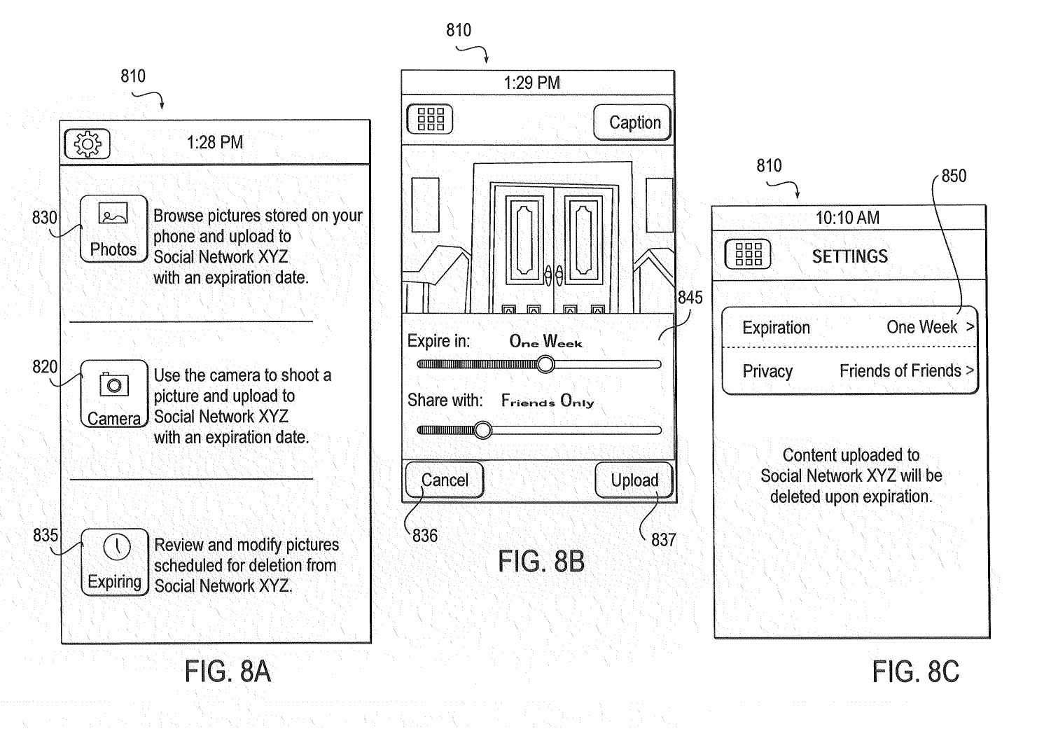

FIG. 8 contains images from a user appliance screen illustrating further aspects of the invention. In FIG. 8A, screen 810 shows icons 820 and 830, which are as described with like numbered elements of FIG. 7. FIG. 8A also includes schedule icon 835, which, if selected, enables a user to review and modify a schedule; for example, a schedule of content deletions according to the process detailed in the flow chart of FIG. 5. FIG. 8B is similar to FIG. 7B, also including a second slider icon to slidably scan through a range of scope-of-sharing parameter values. In FIG. 8B, scope-of-sharing parameters are two-fold: expiry date (one week selected), and pre-determined groups (friends only selected). FIG. 8C illustrates an embodiment where the App. displays scope-of-sharing parameters and selected values without a slider icon. In this embodiment, a user can navigate a menu tree 850 by touching screen 810.

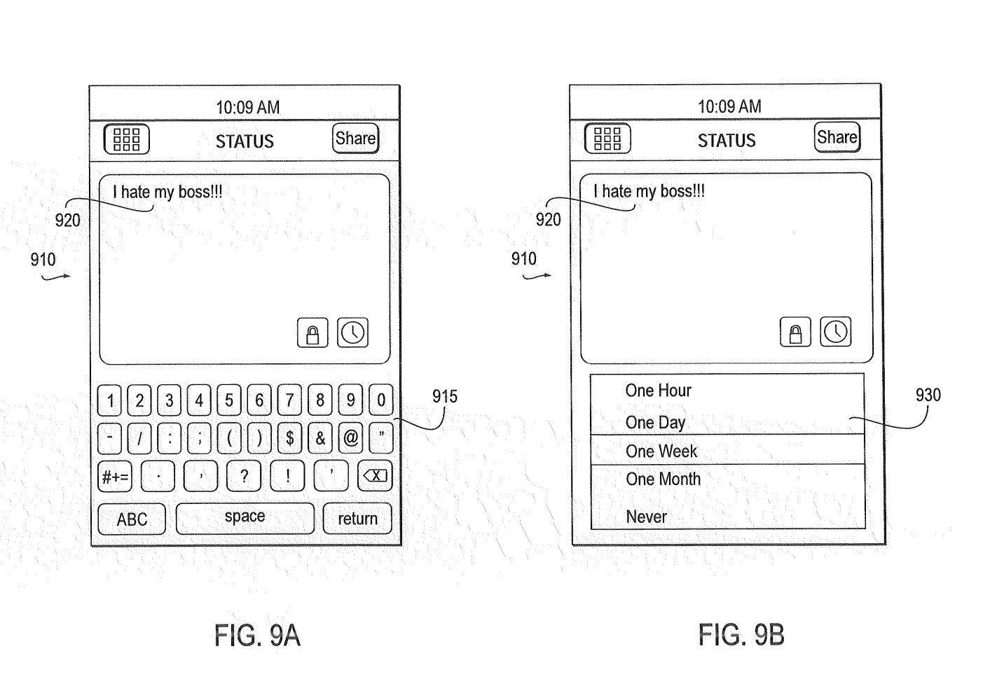

FIG. 9 contains images from a user appliance screen illustrating further aspects of the invention in relation to text content. In FIG. 9A, screen 910 shows keyboard 915 and text content 920, in the form of a Facebook “STATUS” message. In FIG. 9B, the screen shows the text content, as well as slider icon 930. In this wheel-type slider icon, the user has selected an expiry date of one week for her status “I hate my boss!!!”

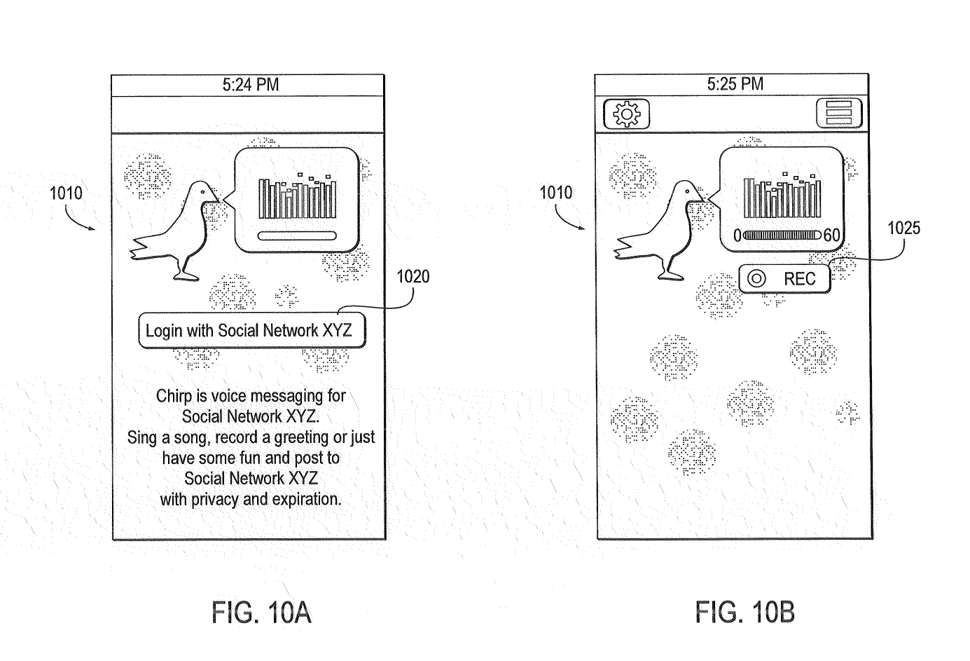

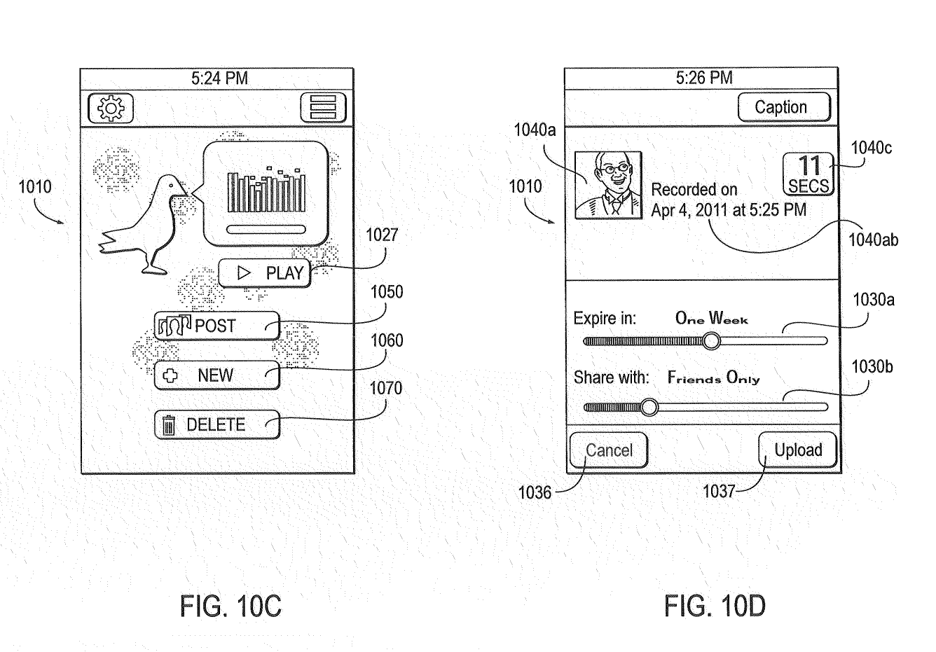

FIG. 10 contains images from a user appliance screen illustrating further aspects of the invention in relation to audio content. In FIG. 10A, screen 1010 shows login icon 1020, which the user selects to initiate logging into a sharing service, such as Facebook. FIG. 10B shows the screen and record icon 1025, which the user selects to create audio content by making a recording; for example, the user may speak a message into a microphone incorporated into the user appliance. FIG. 10C shows screen 1010; playback icon 1027, which the user selects to hear newly-created audio content; post icon 1050, which the user selects to proceed to upload the newly-created audio content to a sharing service such as Facebook; add icon 1060, which the user selects to create further audio content; and delete icon 1070, which the user selects to delete the newly created audio content: for example if, after reviewing the recording by selecting the playback icon, the user is not satisfied with the recording, the user may select the delete icon to eliminate the recording. FIG. 10D shows screen 1010 after a user elected to proceed from the screen in FIG. 10C by selecting the post icon. Content representation 1040a-c and slider icons 1030a-b prompt a user to select parameters to determine a scope-of-sharing for the content, as described above with respect to FIGS. 6-8; for the example of the recorded message, an expiry date of one week for the recorded message, and sharing with friends only. Cancel icon 1036 and upload icon 1037, respectively, enable the user to nullify the posting procedure and proceed to initiate transmission of the audio content to the sharing service, in manners similar to the foregoing description of FIGS. 6-8.

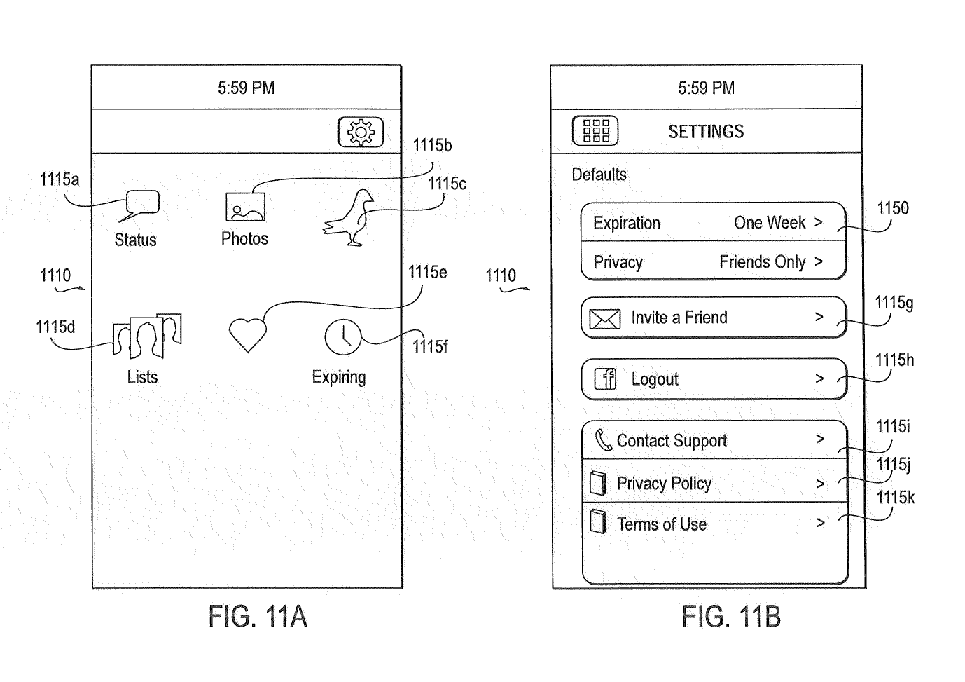

FIG. 11 contains images from a user appliance screen illustrating further features of embodiments of the invention. FIG. 11A shows screen 1110 in an embodiment where the App. presents function icons 1115, which are akin to those described with respect to FIG. 6. In this manner of presentment of function by icon, the App. presents a user-friendly overview of key functions relating to, for example, creating and viewing text content (1115a; status on Facebook, say), photo content (1115b), sound content (1115c), lists (1115d), associating scope-of-sharing parameters with content (1115e), and scheduling application of scope-of-sharing parameters (1115f). Many other variations are possible in alternate embodiments. FIG. 11B illustrates another aspect of the invention: the App. prompts the user to select default settings for scope-of-sharing parameters. In FIG. 11B, screen 1110 shows default menu 1150, in which a user selected default settings for expiry date of one week and sharing with friends only. FIG. 11B also includes functional icons 1115g-k for, respectively, inviting a person to an action, say viewing recently uploaded content; logging out of the sharing service, say Facebook; contacting support services of a service, say; and for reviewing policies and software terms of use. Many variations are apparent to the skilled person.

As described above, the invention is readily adoptable by a sharing service. Returning to FIG. 3, sharing service 304 includes control computer 350 and servers 305. The sharing servers, in addition to sharing content, distribute software, such as the App. described above, to user appliances. In alternate embodiments, the sharing service's other computers distribute software to users, or to third parties such as user appliance manufacturers. In one class of such embodiments, the user appliance, running the software, has the functionality of the control computer described in the written description, above, and figures. For example, the user appliance runs software that includes both an App. and other instructions to act as the user's agent to implement a scope-of-sharing schedule with the sharing service.

This specification discloses a method and system for limited sharing of digital content. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

We claim:

1. A computer-implemented method, comprising:
receiving a first data stream from a user appliance over a network, the first data stream including user-authentication and content; and
receiving a second data stream from a control computer, the second data stream including user-determined content sharing instructions.

2. The method of claim 1, wherein the control computer is the user appliance, and the sharing instructions include a schedule.

3. The method of claim 1, wherein the second data stream is received over a public network.

4. The method of claim 1, wherein the sharing instructions are based on parameters selected by the user responsive to a prompt, the prompt including a representation of the content.

5. Computer storage media having embodied thereon computer-usable instructions that, when executed, perform the method of claim 1.

6. A computer-implemented method, comprising:
presenting the user with a prompt to select at least one scope-of-sharing parameter;
receiving the at least one scope-of-sharing parameter from the user;
generating first sharing instructions based on the at least one scope-of-sharing parameter;
initiating transmission of user-authentication and content to a sharing service; and
initiating transmission of user-authentication and second sharing instructions to a control computer, the control computer configurable to communicate with the sharing service to establish the selected scope-of-sharing by executing the second sharing instructions.

7. The method of claim 6, wherein the prompt includes a representation of the content to be limited by the at least one scope-of-sharing parameter.

8. The method of claim 6, wherein the second sharing instructions are the first sharing instructions.

9. The method of claim 6, wherein the prompt includes a representation of a range of scope-of-sharing parameter values.

10. The method of claim 6, further including: transmitting user-authentication to the sharing service; and receiving an access token and token expiration time from the sharing service.

11. The method of claim 10, wherein the user-authentication transmitted to the control computer includes the access token.

12. The method of claim 10, wherein the user-authentication transmitted to the sharing service includes the access token.

13. The method of claim 6, further including: receiving a content identifier from the sharing service; and initiating transmission of the content identifier to the control computer in combination with the user-identification and first sharing instructions.

14. The method of claim 6, wherein the prompt is presented after the content is created.

15. The method of claim 6, wherein the content includes metadata.

16. The method of claim 6, wherein the at least one scope-of-sharing parameter received after the prompt is a default value of the parameter.

17. Computer storage media having embodied thereon computer-usable instructions that, when executed, perform the method of claim 6.

18. A system comprising:
a software distribution component that transfers computer-usable instructions that, when executed on a user appliance, associate content to be shared with at least one user-selected scope-of-sharing parameter; and
a control component that is configurable to receive sharing instructions from the user appliance, and transmit the sharing instructions to the content sharing service in a form adapted to the sharing service.

19. The system of claim 18, further including a content sharing component that shares content according to the user-determined scope-of-sharing.

20. The system of claim 18, wherein the computer-usable instructions prompt the user to select scope-of-sharing parameters by providing a representation of the content to be shared.
